(19) United States
(12) Patent Application Publication
(10) Pub. No.: US 2007/0279812 A1
(43) Pub. Date: Dec. 6, 2007

(54) LIGHT-EMITTING DIODE LIGHTING CIRCUIT, ILLUMINATING DEVICE AND LIQUID CRYSTAL DISPLAY DEVICE

(75) Inventor: KENICHI SASAKI, Miyagi (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/755,221

(22) Filed: May 30, 2007

(30) Foreign Application Priority Data
May 31, 2006 (JP) 2006-152425

(51) Int. Cl. H02H 7/00

(52) U.S. Cl. 361/1

(57) ABSTRACT

A light-emitting diode lighting circuit is provided. The light-emitting diode lighting circuit includes: a plurality of light-emitting diodes connected in series, and a protective element connected in parallel to each of the plurality of light-emitting diodes, in which in the case where an open-circuit failure is caused in the light-emitting diode, dielectric breakdown occurs in the protective element connected in parallel to the light-emitting diode.

### CROSS REFERENCES TO RELATED APPLICATIONS

The present application claims priority to Japanese Patent Application JP 2006-152425 filed in the Japanese Patent Office on May 31, 2006, the entire contents of which is being incorporated herein by reference.

### BACKGROUND

The present application relates to a light-emitting diode lighting circuit, an illuminating device and a liquid crystal display device that include a protecting function when an open-circuit failure is caused.

A light emitting diode (LED) used for a backlight device in a liquid crystal display device may stop lighting due to a failure at the end of the product's life, for example. There are three major failure modes in individual elements:

(1) an open-circuit failure where connection is broken;

(2) a short-circuit failure where short-circuit occurs; and

(3) neither of the above, a mode where an amount of light gradually lowers.

Various kinds of countermeasures are carried out against those failures. For example, Japanese Unexamined Patent application Publication No. 2002-335012 discloses a technology described below as a countermeasure against a failure caused by the open-circuit mode. Specifically, there is provided a light-emitting diode including: a light emitting element using a nitride semiconductor having Ga at least in a light emitting layer, and a semiconductor protective element being connected in parallel to the light emitting element and electrically protecting the light emitting element. Particularly, the semiconductor protective element connected in parallel to the light emitting element is electrically conducted in both the forward and reverse directions with a voltage larger than the forward voltage of the light emitting element.

### SUMMARY

In order to detect the failures, a method of driving respective light-emitting diodes independently by individual driving circuits is employed in the related art, and a system in which an operational condition of each light-emitting diode is constantly fed back may be needed. However, it is difficult to actually obtain such method and system due to high production costs.

In the case where light-emitting diodes are used for a backlight (illumination) in a liquid crystal display device, electric power of the individual light-emitting diode is large and the number of the light-emitting diodes is comparatively small. Therefore, if there is a non-lighting portion in the backlight device due to a failure or the like, color unevenness or the like is caused on the display and picture quality may be degraded.

Further, a light-emitting diode driving device used for illumination may not include a matrix driven LSI (Large Scale Integration) for large electric power drive or the like and practically it is disadvantageous in respect of costs, and therefore a series-drive-connection method may be used. When using the series-connection method, there is such a problem that all the diodes in one row may stop lighting to cause serious color unevenness, if a failure of an individual light-emitting diode occurs and the failure is caused by a broken wire. Also, in the case where the protection of the light-emitting diode is carried out with a thyristor or the like, a large-scale circuit (requiring more space) and high costs may be needed.

In view of the above, it is desirable to avoid non-lighting of all the light-emitting diodes in one row that are connected in series, with a simplified configuration, when the open-circuit failure of the light-emitting diode occurs.

According to an embodiment, there is provided a light-emitting diode lighting circuit including: a plurality of light-emitting diodes connected in series and a protective element connected in parallel to each of the plurality of light-emitting diodes, in which in the case where an open-circuit failure is caused in the light-emitting diode, dielectric breakdown occurs in the protective element connected in parallel to the light-emitting diode.

According to the above configuration, the protective element may be short-circuited by the dielectric breakdown with a potential difference applied to the light-emitting diode at the time of the open-circuit failure of the light-emitting diode, thereby preventing non-lighting of the light-emitting diodes connected in series.

According to an embodiment, there is provided an illuminating device including a light-emitting diode lighting circuit that includes: a plurality of light-emitting diodes connected in series and a protective element connected in parallel to each of the plurality of light-emitting diodes, in which in the case where an open-circuit failure is caused in the light-emitting diode, dielectric breakdown occurs in the protective element connected in parallel to the light-emitting diode.

According to the above configuration, the protective element may be short-circuited by the dielectric breakdown with a potential difference applied to the light-emitting diode at the time of the open-circuit failure of the light-emitting diode, thereby preventing non-lighting of the light-emitting diodes connected in series.

According to an embodiment, there is provided a liquid crystal display device illuminated by a backlight device including a light-emitting diode lighting circuit that includes: a plurality of light-emitting diodes connected in series and a protective element connected in parallel to each of the plurality of light-emitting diodes, in which in the case where an open-circuit failure is caused in the light-emitting diode, dielectric breakdown occurs in the protective element connected in parallel to the light-emitting diode.

According to the above configuration, the protective element may be short-circuited by the dielectric breakdown with a potential difference applied to the light-emitting diode at the time of the open-circuit failure of the light-emitting diode, thereby preventing non-lighting of the light-emitting diodes connected in series.

In the light-emitting diode lighting circuit according to the embodiments, such a condition that all the light-emitting diodes connected in series in one row stop lighting can be prevented by a simplified configuration using dielectric breakdown, thereby stabilizing the lighting state of the light-emitting diode.

Further, in the case where an illuminating device including the aforementioned light-emitting diode lighting circuit is used for a backlight device in a liquid crystal display device, the liquid crystal display panel can be illuminated stably.

Furthermore, according to the liquid crystal display device using the aforementioned backlight device, since the liquid crystal display panel is illuminated stably, picture quality can also be stabilized.

Additional features and advantages are described herein, and will be apparent from, the following Detailed Description and the figures.

### BRIEF DESCRIPTION OF THE FIGURES

FIG. 1 is a schematic exploded view of a liquid crystal display device.

FIG. 2 is a diagram showing an example of alignment of light-emitting diodes in a backlight device.

FIG. 3 is a diagram showing an example of wiring of light-emitting diodes in a backlight device.

FIG. 4 is a diagram showing an example of arrangement of a light source substrate in a backlight device.

FIG. 5 is a diagram showing an example of a configuration of a driving circuit in a backlight device.

FIG. 6 is a diagram showing an example of a series circuit of light-emitting diodes in a backlight device.

FIG. 7 is a circuit diagram according to a first embodiment.

FIG. 8 is a diagram showing a relationship between a voltage applied to a protective element and a current thereof according to the first embodiment.

FIGS. 9A and 9B are diagrams showing an example of a configuration of the light-emitting diodes according to the first embodiment, in which FIG. 9A is a top view and FIG. 9B is a A-A line sectional view.

FIG. 10 is a schematic view showing a current normally flowing through the light-emitting diode (lighting) according to the first embodiment.

FIG. 11 is a schematic view showing a current at an open-circuit mode flowing through the light-emitting diode (non-lighting) according to the first embodiment.

FIG. 12 is a modified example of the circuit diagram shown in FIG. 7.

FIG. 13 is a circuit diagram according to a second embodiment.

FIG. 14 is a diagram showing Vf characteristics of a light-emitting diode and n diodes according to the second embodiment.

FIG. 15 is a modified example of the circuit diagram shown in FIG. 13.

### DETAILED DESCRIPTION

Embodiments of the present application are hereinafter explained with reference to the attached drawings.

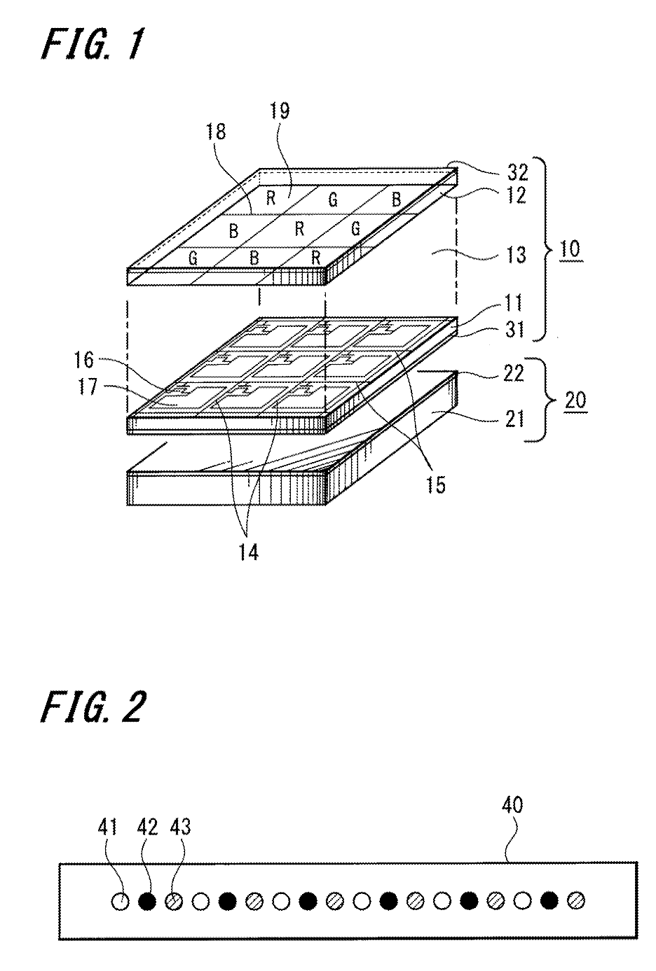

A first embodiment is explained with reference to FIGS. 1 to 12. FIG. 1 is a schematic exploded view showing a configuration of a liquid crystal display device including a backlight device to which an illuminating device having a light-emitting diode lighting circuit according to an embodiment is applied.

The liquid crystal display (LCD) device according to an embodiment may be used for a transmissive color LCD device configured as shown in FIG. 1, for example. The transmissive color LCD device includes a transmissive color LCD panel 10 and a backlight device 20 provided on the rear side of the transmissive color LCD panel 10. Also, although not shown, the transmissive color LCD device may include: a receiving portion such as an analogue tuner or digital tuner that receives ground and satellite waves; a video signal processing portion and audio signal processing portion that process a video signal and audio signal which are received at the receiving portion, respectively; and an audio signal output portion such as a speaker that outputs the audio signal processed at the audio signal processing portion.

The transmissive color LCD panel 10 includes: two transparent substrates (TFT panel 11, facing electrode panel 12) formed of glass or the like and arranged to face each other, and a liquid crystal layer 13 sealed with twisted nematic (TN) liquid crystal, for example, in between the two substrates. Signal lines 14 and scanning lines 15 that are arranged in a matrix, thin-film transistors 16 as switching elements arranged at intersections of the signal lines 14 and the scanning lines 15, and pixel electrodes 17 are formed on the TFT panel 11. The thin-film transistor 16 is sequentially selected by the scanning line 15 and writes a video signal supplied from the signal line 14 to the corresponding pixel electrode 17. On the other hand, facing electrodes 18 and color filters 19 are formed on the inner surface of the facing electrode panel 12.

The transmissive color LCD device includes such transmissive color LCD panel 10 between two polarizing plates 31, 32, then, being illuminated with white light from the rear side using a backlight device 20, and being driven by an active matrix method, thereby displaying a desired full color image.

As shown in FIG. 1, the backlight device 20 includes a light diffusing plate 22 provided on the rear side of the transmissive color LCD panel 10 and a light source 21 that employs an illuminating system using a plurality of light emitting elements (light-emitting diodes). The light diffusing plate 22 diffuses light emitted from the backlight enclosure to the inside, thereby making brightness on the surface emitting uniform. In order to improve the picture quality, a group of optical sheets having various functions such as a diffusing sheet, a prism sheet, a polarization converting sheet and the like may be stacked and arranged on the light diffusing plate 22.

Next, arrangement of the light-emitting diodes in the light source 21 of the backlight device 20 is described with reference to FIG. 2. FIG. 2 shows an example of the arrangement in which total eighteen light-emitting diodes are aligned including six red (R) light-emitting diodes 41, six green (G) light-emitting diodes 42 and six blue (B) light-emitting diodes 43 on a light source substrate 40. It should be noted that an example is not limited to the above, and various other arrangements, combinations or the like capable of obtaining a balanced color mixture may be employed depending on rating, luminous efficiency or the like of the light-emitting diode used.

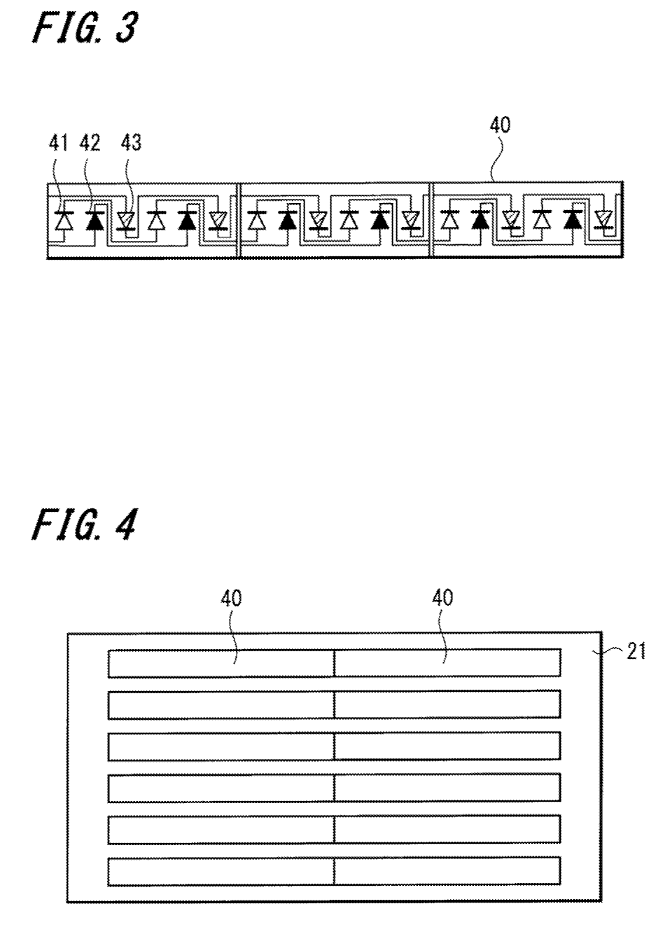

FIG. 3 shows an example of wiring in which the light-emitting diodes 41 to 43 arranged as shown in FIG. 2 are connected in series for each color.

Next, an example of the arrangement of actual light-emitting diodes in the light source 21 of the aforementioned backlight device 20 is explained with reference to FIG. 4. As shown in FIG. 4, the light source 21 according to the embodiment includes total twelve light source substrates (light-emitting diode array) 40 arranged in two columns and six rows.

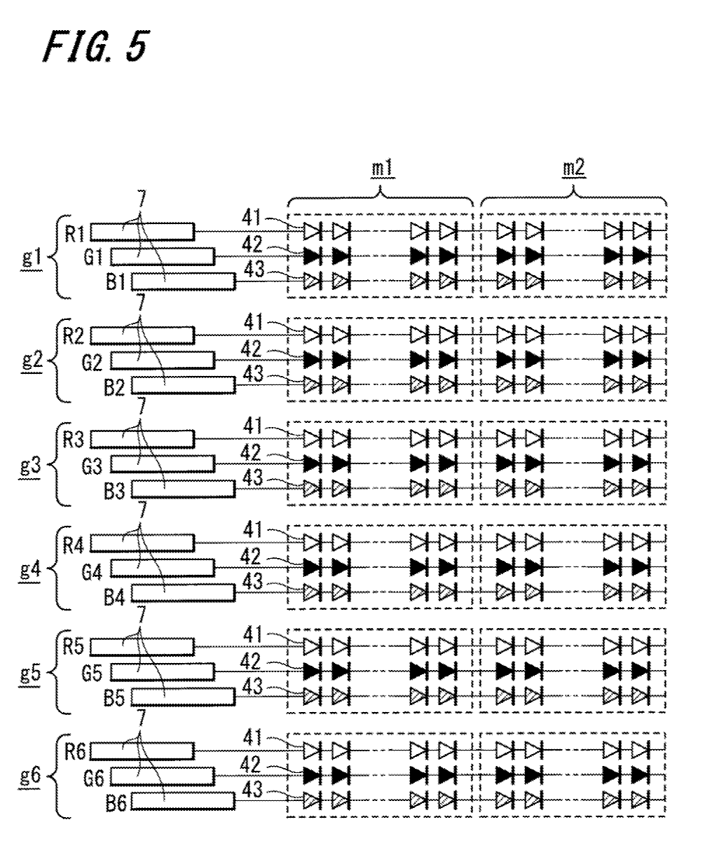

The backlight device 20 uses a driving circuit having a configuration shown in FIG. 5 for the light source substrates 40 shown in FIG. 4. As shown in FIG. 5, DC-DC converters 7 that convert voltage of direct-current power are connected to light-emitting diodes m1, m2 that are connected in series, and the constant current is supplied respectively. Six RGB light-emitting diode sets g1 to g6 corresponding to the six rows include the DC-DC converters 7 for respective colors, and each of the sets g1 to g6 is connected to each of the RGB light-emitting diodes of the light-emitting diodes m1, m2 that are connected in series. For example, in the first row (g1), a constant current is supplied to each of the series-connected light-emitting diodes m1, m2 from the DC-DC converter 7 for the red light-emitting diode. The constant current is similarly supplied to the green and blue light-emitting diodes in the first row. Further, regarding the sets g2 to g6, the constant current is similarly supplied, and so the explanation thereof is herein omitted.

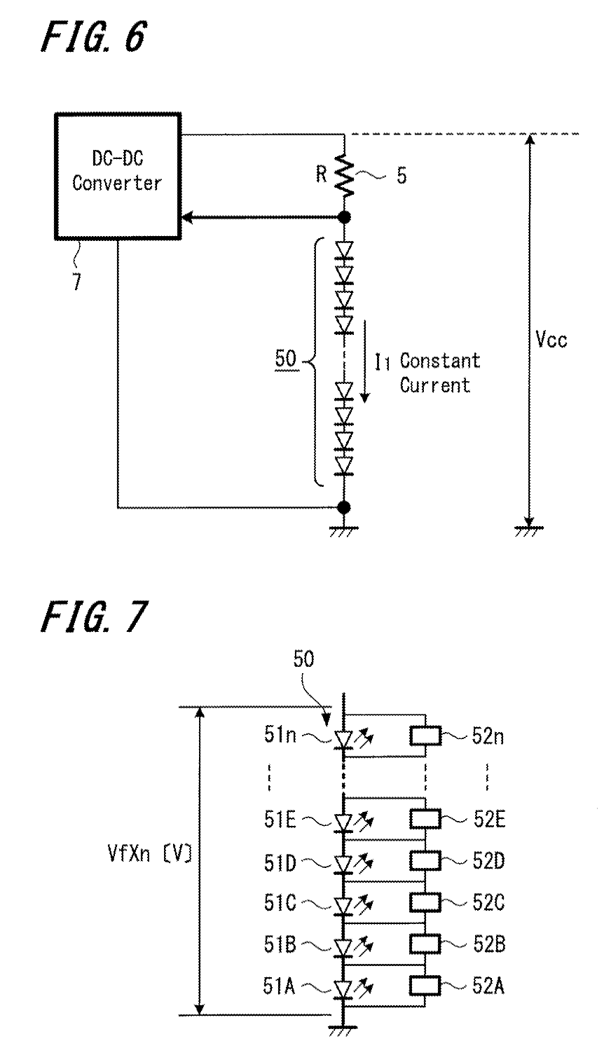

Next, a specific example of a configuration in which the constant current flows through each of the series-connected light-emitting diodes is explained. FIG. 6 shows an example of a series circuit of light-emitting diodes. As shown in FIG. 6, an anode side of a light-emitting diode array 50 where a plurality of light-emitting diodes are connected in series is connected to one end of the DC-DC converter 7 through a resistive element (R) 5, and a cathode side thereof is connected to a ground terminal and to the other end of the DC-DC converter 7. The DC-DC converter 7 detects voltage drop, caused by the resistive element 5, from the set output voltage Vcc and forms a feed back loop so that a predetermined current I1 flows through the light-emitting diode array 50 where the light-emitting diodes are connected in series. The light-emitting diode array 50 shown in FIG. 6 corresponds to one row (m1 or m2) of the RGB sets g1 to g6 corresponding to six rows shown in FIG. 5, respectively. Therefore, according to this embodiment, the similar circuit may be required for each of the six rows (g1 to g6) and for respective colors RGB, that is, 18 circuits in total.

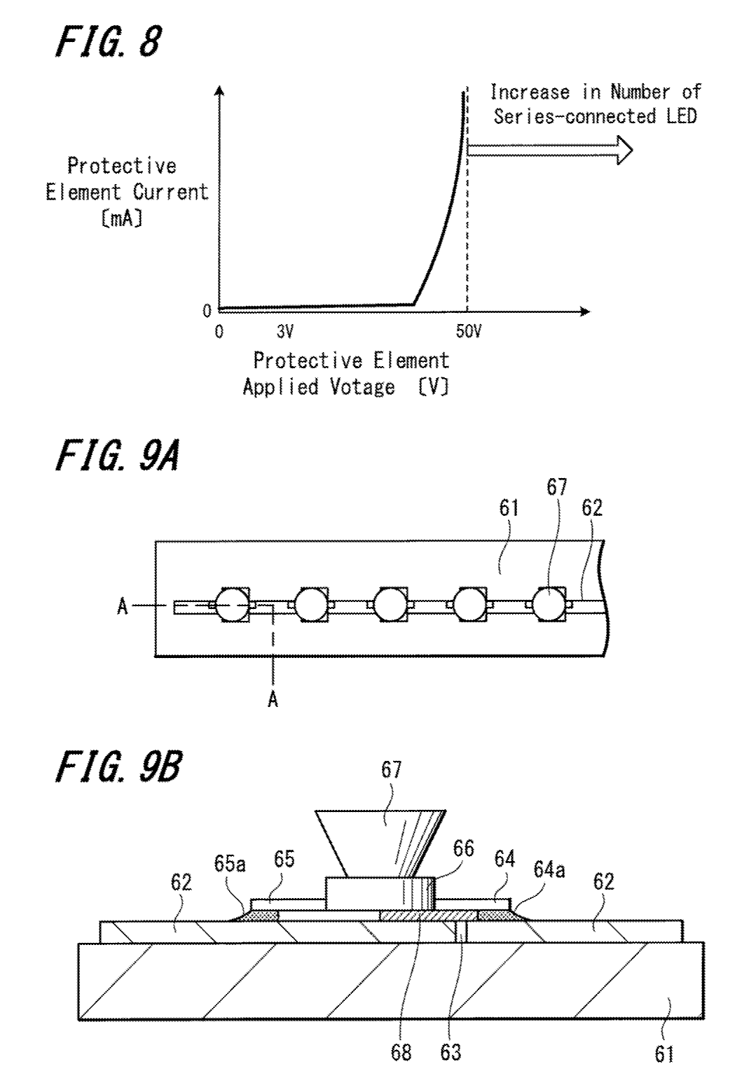

Subsequently, referring to FIGS. 7 and 8, a configuration for avoiding a non-lighting mode in the backlight device 20 is described. Specifically, in the case where a plurality of series-connected light-emitting diodes are driven with the constant current, when the open-circuit failure of an element occurs, the element is short-circuited by means of dielectric breakdown or the like caused in a protective element by a potential difference applied to the element.

FIG. 7 shows a light-emitting diode lighting circuit according to a first embodiment. According to the embodiment, respective protective elements 52A to 52n are connected in parallel to n (n is a positive integer) series-connected light-emitting diodes 51A to 51n corresponding to a light-emitting diode array 50 shown in FIG. 6. A potential difference “V” applied to the whole of the light-emitting diode array 50 is represented by:

V=Vf×n

where Vf represents a voltage level of the forward voltage drop of each light-emitting diode.

In the light-emitting diode lighting circuit shown in FIG. 7, current does not flow through each protective element with an open-circuit at a normal operation. On the other hand, in the case where the open-circuit failure is caused in one of the above-described light-emitting diodes 51A to 51n, approximately the same voltage as Vf×n[V] is applied to one of the above-described protective elements. With the voltage applied, the protective element is short-circuited by dielectric breakdown or the like and is electrically conducted, and therefore the series-connected light-emitting diode array 50 is returned to a lighting state.

Next, a relationship between the dielectric breakdown voltage applied to the protective element and the current flowing through the protective element is described. FIG. 8 is a characteristic curve showing a relationship between a voltage applied to the protective element and a current flowing therein, and a horizontal axis represents the voltage [V] applied to the protective element and a vertical axis represents the current [mA] flowing through the protective element. FIG. 8 shows an example in which the protective element is in an open-circuit state, in other words, the current does not flow in the protective element, when the applied voltage (Vf) is in the range of 2 to 3 [V] of one light-emitting diode being lit at the normal time, but the dielectric breakdown or the like is caused when the applied voltage exceeds 50 [V] and the protective element is short-circuited. If a voltage level of the forward voltage drop of the light-emitting diode is about 2 [V], 25 or more light-emitting diodes, the number of which is obtained by dividing 50 [V] by 2 [V] (Vf voltage), are connected in series to protect the light-emitting diodes, in the case of the protective element where dielectric breakdown or the like occurs with a voltage of about 50 V as shown in the example in FIG. 8. The number of light-emitting diodes connected in series is increased if a large margin (threshold voltage) may be needed for the protecting operation at that time. More specifically, a threshold voltage with which the protecting operation is started can be set corresponding to the number of the light-emitting diodes.

Here, a configuration of the light-emitting diode used in a light-emitting diode lighting circuit according to the first embodiment is described. FIGS. 9A and 9B are schematic diagrams showing an example of a configuration of the light-emitting diodes, in which FIG. 9A is a top view of a light source substrate where the light-emitting diodes are arranged, and FIG. 9B is an A-A line sectional view. As shown in FIG. 9B, a wiring pattern 62 that includes a gap 63 at a predetermined interval is formed on the upper surface of the light source substrate 61, and a light-emitting diode chip 66 including lead terminals 64, 65 is mounted thereon. The wiring pattern 62 and respective lead terminals 64, 65 are fixed by solders 64a, 65a, respectively. The light-emitting diode chip 66 is sealed with a light-emitting diode cap 67 formed with a transparent resin or the like. Further, an insulating layer 68 formed of an insulating material such as SiO₂, for example, is provided between the light-emitting diode chip 66 and the wiring pattern 62, and the insulating layer 68 is formed to fill the gap 63 formed in the wiring pattern 62.

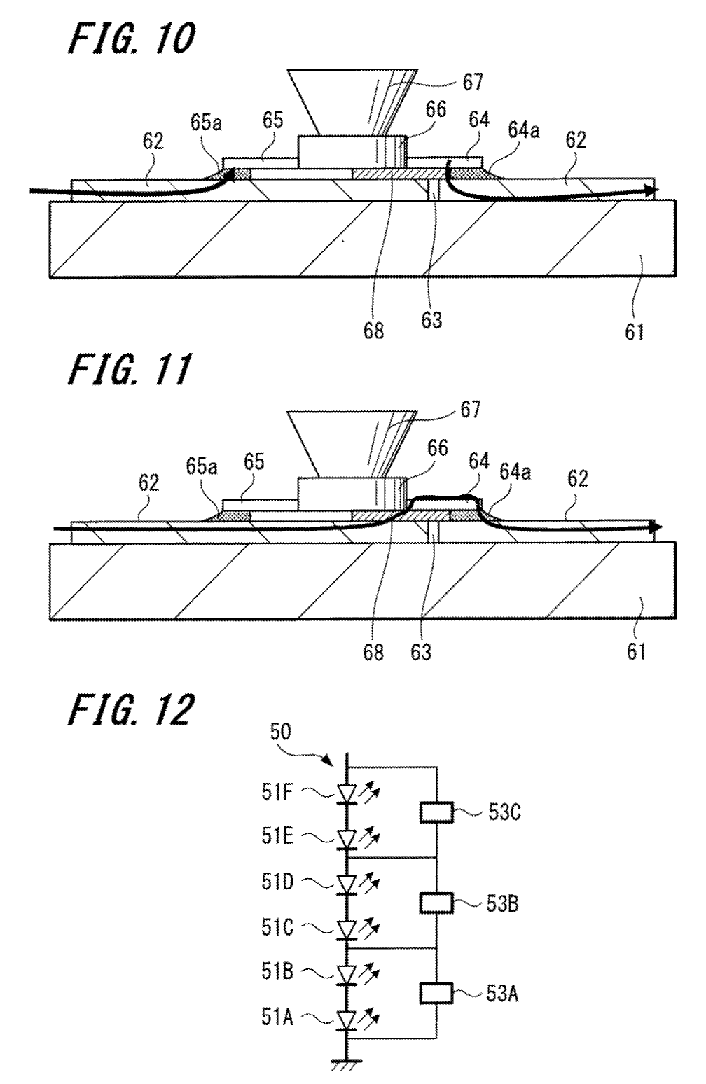

A function of a protective element in the case where a voltage is applied to a light-emitting diode is described. FIG. 10 is a schematic diagram showing a current flowing through the light-emitting diode at a normal time (lighting). FIG. 11 is a schematic diagram showing a current flowing through the light-emitting diode at the time of open-circuit (non-lighting).

As shown in FIG. 10, dielectric breakdown of the protective element 68 may not occur at the normal time with the forward voltage drop Vf of the light-emitting diode. Therefore, the current supplied from the DC-DC converter 7 (see FIG. 6) flows from the wiring pattern 62 on one side to the wiring pattern 62 on the other side, through the lead terminal 65 formed on one side of the light-emitting diode chip 66, the light-emitting diode chip 66 and the lead terminal 64 on the other side thereof.

However, in the case where the light-emitting diode is in the open-circuit failure, dielectric breakdown occurs in the protective element 68 brought to the short-circuit mode. As shown in FIG. 11, at this time, the current supplied from the DC-DC converter 7 (see FIG. 6) flows from the wiring pattern 62 on one side to the wiring pattern 62 on the other side, through the insulating layer 68 with dielectric breakdown and the lead terminal 64.

It should be noted that other insulating materials than SiO₂ may also be selected from various suitable materials without limiting thereto. Also, the voltage level at which the dielectric breakdown is started may be adjusted by changing the thickness of the insulating layer.

Next, a modified example of the circuit shown in FIG. 7 is described with reference to FIG. 12. As shown in FIG. 12, the same numerals are given to portions corresponding to those in FIG. 7, and a detailed explanation thereof is omitted. In this modified example, one protective element is connected in parallel to a plurality of light-emitting diodes that are connected in series. In the circuit shown in FIG. 12, one protective element is connected in parallel to two light-emitting diodes that are connected in series. A protective element 53A, a protective element 53B and a protective element 53C are connected in parallel to the light-emitting diodes 51A, 51B, the light-emitting diodes 51C, 51D and the light-emitting diodes 51E, 51F, respectively. As shown in FIG. 12, a plurality of bypass diodes may be connected in series to a plurality of light-emitting diodes, instead of being connected to one light-emitting diode, at the level with no possibility of color mixture of light-emitting diodes. Accordingly, the number of the protective elements necessary for one light-emitting diode lighting circuit can be reduced. It should be appreciated that there are other examples in which one protective element is provided for three or more light-emitting diodes shown in FIG. 12.

According to the above-described first embodiment and modified example thereof, in the case where a series-connected plurality of light-emitting diodes are driven with the constant current, the non-lighting mode can be avoided by causing the dielectric breakdown in the protective element to be short-circuited by means of the potential difference applied to the light-emitting diode at the time of the open-circuit failure of the light-emitting diode.

Further, since the light-emitting diode lighting circuit is formed on a heat dissipating substrate (light source substrate) where a light-emitting diode is mounted, a problem of rise in temperature can be avoided.

Further, the dielectric breakdown voltage may arbitrarily be set depending on the forward voltage drop Vf of series-connected light-emitting diodes and the number thereof.

Accordingly, such a condition that all the light-emitting diodes connected in series in one row stop lighting may be avoided with a simplified configuration in which dielectric breakdown is caused in the protective element provided to the light-emitting diode chip. Therefore, the lighting condition of the light-emitting diodes may be stabilized and the reliability of the light-emitting diode lighting circuit may be improved.

Furthermore, in the case where an illuminating device including such light-emitting diode lighting circuit is applied to a backlight device in a LCD device, a stabilized lighting operation of the backlight may be obtained, thereby the picture quality on the LCD device being improved.

It should be noted that the example in which the illuminating device according to an embodiment is applied to the backlight device in the LCD device is described, however, the illuminating device according to the embodiment is not limited thereto and may be applied to a display device.

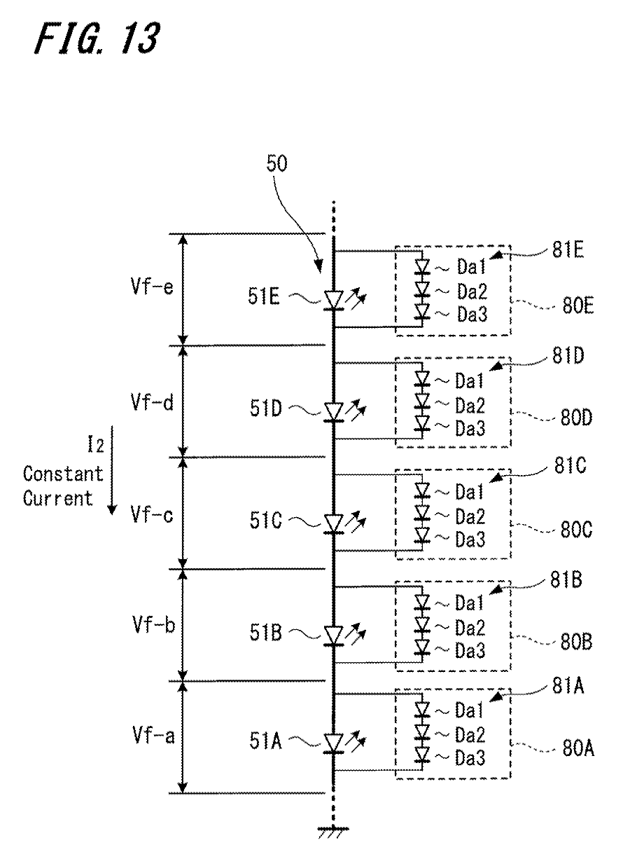

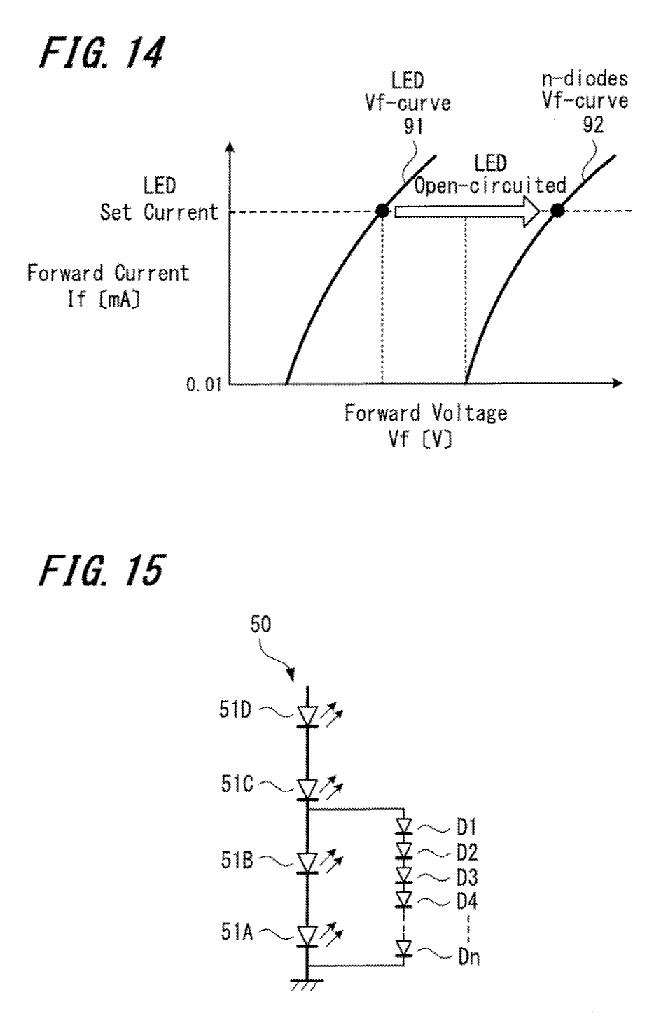

Next, a second embodiment is described. According to the second embodiment, in the case where a plurality of series-connected light-emitting diodes are driven with a constant current in the backlight device 20, at the time of the open-circuit failure of the light-emitting diode, current is allowed to automatically bypass the failed part. FIG. 13 shows a circuit diagram according to the second embodiment and FIG. 14 shows characteristic curves showing the Vf characteristics of a light-emitting diode and n diodes. Here, as shown in FIGS. 13 and 14, the same numerals are given to portions corresponding to those in FIGS. 1 to 12, and the detailed explanation thereof is herein omitted.

In the circuit shown in FIG. 13, five light-emitting diodes 51A to 51E connected in series include bypass circuits 80A to 80E having diodes 81A to 81E connected in parallel individually. Three series-connected diodes Da1 to Da3 are connected to each of the diodes 81A to 81E. In the example shown in FIG. 13, the DC-DC converter 7 (see FIG. 6) detects a voltage drop from the set output voltage Vcc by the resistive element 5 and a predetermined current 12 flows through the series-connected light-emitting diode array 50, thereby forming a feedback loop.

In the above diodes 81A to 81E, the sum of the forward voltage drop Vf of respective diodes (the sum of Vf of Da1, Da2 and Da3) is set to be higher than the forward voltage drop (Vf-a to Vf-e) of the series-connected light-emitting diodes 51A to 51E, and the current does not flow through the diodes 81A to 81E at the normal operation. Here, a value of the forward voltage drop Vf is set so that the current flows through the above diodes 81A to 81E in the case where the above diodes 51A to 51E are in the open-circuit state.

Next, the relationship between the light-emitting diodes 51A to 51E and diodes 81A to 81E, and the forward voltage drops Vf with referring to FIG. 14. The voltage level of the forward voltage drop Vf is set low as shown in a light-emitting diode Vf-curve 91 as compared to a series-connected n-diodes (three in this embodiment) Vf-curve 92. Specifically, the current that flows through the light-emitting diode at the normal time is less than 0.01 [mA] which is obtained from the Vf-curve of the diode.

On the other hand, current starts to flow with the value of the current set for the n-diodes Vf-curve when the light-emitting diode is in the open-circuit failure. Thus, the light-emitting diode having the failure is bypassed efficiently and the other series-connected light-emitting diodes are capable of lighting. It should be noted that a large current for obtaining the brightness for the backlight flows through the bypass diode at that time.

Accordingly, the bypass diode is configured within the light source substrate (metal substrate, for example) that dissipates heat of the light-emitting diode and also functions as the heat dissipation substrate shown in FIG. 2, and the temperature rise in the element caused by the large current is avoided. Since the system is configured in combination with the constant current drive, the thermal design may be made without difficulty.

It should be noted that the bypass diode is externally provided in the above-described embodiment; however, the function of the bypass diode may be included in the light-emitting diode chip, as an application example thereof.

Furthermore, as a modified example, as shown in FIG. 15, a plurality of bypass diodes may be connected in series to a plurality of light-emitting diodes, instead of being connected to one light-emitting diode, at the level with no possibility of color mixture of light-emitting diodes. Here, as shown in FIG. 15, the same numerals are given to portions corresponding to those in FIG. 13, and the detailed explanation thereof is herein omitted. In the circuit shown in FIG. 15, n (D1 to Dn) bypass diodes are connected to two series-connected light-emitting diodes (51A, 51B). It should be appreciated that the number of light-emitting diodes is not limited to two in the above-described example shown in FIG. 15.

According to the second embodiment and modified example described above, since the bypass circuit that operates with a voltage higher than the forward voltage drop of the light-emitting diode is connected in parallel to the light-emitting diode, the bypass circuit is operated and the non-lighting is avoided at the time of the open-circuit failure of the light-emitting diode, in the case where a plurality of series-connected light-emitting diodes are driven with the constant current.

Since the condition that a series-connected light-emitting diode array is completely disabled can be avoided as described above, the lighting condition of the light-emitting diodes can be stabilized, and consequently the operation of the backlight device and the picture quality of the LCD device can be stabilized, thereby improving reliability of respective circuits and devices.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A light-emitting diode lighting circuit comprising:
a plurality of light-emitting diodes connected in series, and
a protective element connected in parallel to each of the plurality of light-emitting diodes, wherein
in the case where an open-circuit failure is caused in the light-emitting diode, dielectric breakdown occurs in the protective element connected in parallel to the light-emitting diode.

2. A light-emitting diode lighting circuit according to claim 1, wherein
the dielectric breakdown occurs in the protective element when a potential difference applied to the protective element is larger than a voltage Vf representing a forward voltage drop in the light-emitting diode.

3. A light-emitting diode lighting circuit according to claim 2, wherein
in the case where the open-circuit failure is caused in the light-emitting diode, a relationship is represented by
V≈Vf×n
where V represents the potential difference applied to the protective element connected in parallel to the light-emitting diode and n represents the number of the light-emitting diodes connected in series.

4. A light-emitting diode lighting circuit according to claim 1, wherein:
the protective element is an insulating layer formed between a light-emitting diode chip fixed on a substrate and a wiring pattern formed on the substrate; and
in the case where an open-circuit failure is caused in the light-emitting diode, the dielectric breakdown occurs in the insulating layer corresponding to the light-emitting diode, and the wiring pattern on the substrate and a lead terminal formed on the light-emitting diode chip are electrically conducted through the insulating layer.

5. An illuminating device comprising
a light-emitting diode lighting circuit including
a plurality of light-emitting diodes connected in series, and
a protective element connected in parallel to each of the plurality of light-emitting diodes, wherein
in the case where an open-circuit failure is caused in the light-emitting diode, dielectric breakdown occurs in the protective element connected in parallel to the light-emitting diode.

6. A liquid crystal display device illuminated by a backlight device, comprising
a light-emitting diode lighting circuit including
a plurality of light-emitting diodes connected in series, and
a protective element connected in parallel to each of the plurality of light-emitting diodes, wherein
in the case where an open-circuit failure is caused in the light-emitting diode, dielectric breakdown occurs in the protective element connected in parallel to the light-emitting diode.
